(19) United States
(12) Patent Application Publication
(10) Pub. No.: US 2015/0197645 A1
(43) Pub. Date: Jul. 16, 2015

(54) METHOD OF MANUFACTURING NON-FIRING TYPE ELECTRODE

(71) Applicant: E I DU PONT DE NEMOURS AND COMPANY, Wilmington, DE (US)

(72) Inventors: AKIRA INABA, KAWASAKI-SHI (JP); SATOMI YAMASHITA, KAWASAKI-SHI (JP)

(21) Appl. No.: 14/558,895

(22) Filed: Dec. 3, 2014

Related U.S. Application Data
(60) Provisional application No. 61/928,104, filed on Jan. 16, 2014.

(51) Int. Cl. C09D 5/24; H01M 4/04; H01M 4/1395; H01B 1/02

(52) U.S. Cl. CPC C09D 5/24; H01B 1/026; H01M 4/0402; H01M 4/0471; H01M 4/1395

(57) ABSTRACT

A method of manufacturing a non-fired type electrode comprising steps of: (a) applying a conductive paste on a substrate, wherein the conductive paste comprises, (i) 100 parts by weight of a conductive powder, (ii) 0.1 to 8 parts by weight of an inorganic boron compound selected from the group consisting of boron oxide, boric acid, ammonium borate hydrate, borax, potassium tetraborate tetrahydrate and a mixture thereof, wherein the boron component in the inorganic boron compound is 0.05 to 0.6 parts by weight, (iii) 0.1 to 8 parts by weight of an alcohol selected from the group consisting of glycerin, xylose and a mixture thereof, and (iv) an organic vehicle; and (b) heating the applied conductive paste at 100 to 300° C.

### FIELD OF INVENTION

The present invention relates to a method of manufacturing a non-fired type electrode using a conductive paste.

### TECHNICAL BACKGROUND OF THE INVENTION

Electrical devices or substrates which can be damaged by high temperature treatment during manufacturing process need a non-fired type electrode. The term “non-fired type electrode” is defined as an electrode formed without a heat treatment at a temperature of 350° C. or higher.

US20060082952 discloses a method to form a non-fired type electrode, the method comprises steps of screen printing a conductive paste onto a glass substrate and curing the printed conductive paste at 200° C. or lower. The conductive paste comprises a silver powder with a mean particle size of 1 μm or less, tetrafluoroethylene, hexafluoropropylene, and vinylidene fluoride dispersed in a solvent.

### BRIEF SUMMARY OF THE INVENTION

An objective is to provide a method of manufacturing a non-fired type electrode, which enables the formation of an electrode with a sufficient electrical property.

An aspect of the invention relates to a method of manufacturing a non-fired type electrode comprising the steps of: (a) applying a conductive paste on a substrate, wherein the conductive paste comprises, (i) 100 parts by weight of a conductive powder, (ii) 0.1 to 8 parts by weight of an inorganic boron compound selected from the group consisting of boron oxide, boric acid, ammonium borate hydrate, borax, potassium tetraborate tetrahydrate and a mixture thereof, wherein the boron component in the inorganic boron compound is 0.05 to 0.6 parts by weight, (iii) 0.1 to 8 parts by weight of an alcohol selected from the group consisting of glycerin, xylose and a mixture thereof, and (iv) an organic vehicle; and (b) heating the applied conductive paste at 100 to 300° C.

Another aspect of the invention relates to a non-fired type conductive paste comprising: (i) 100 parts by weight of a conductive powder; (ii) 0.1 to 8 parts by weight of an inorganic boron compound selected from the group consisting of boron oxide, boric acid, ammonium borate hydrate, borax, potassium tetraborate tetrahydrate and a mixture thereof, wherein the boron component in the inorganic boron compound is 0.05 to 0.6 parts by weight; (iii) 0.1 to 8 parts by weight of a alcohol selected from glycerin, xylose and a mixture thereof; and (iv) an organic vehicle.

Another aspect of the invention relates to an electrical device comprising the non-fired type electrode manufactured by the method described above.

The non-fired type electrode with a sufficient electrical property can be formed by the present invention.

### BRIEF DESCRIPTION OF THE DRAWINGS

FIG. 1 is a cross sectional diagram of the electrode formed on a substrate.

### DETAILED DESCRIPTION OF THE INVENTION

The non-fired type electrode is formed by using a conductive paste. The method of manufacturing the electrode and the conductive paste used therein is explained respectively below.

### Method of Manufacturing Electrode

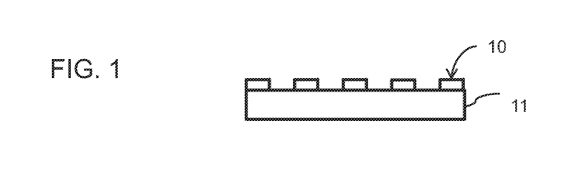

The method of manufacturing an electrode comprises the steps of applying the conductive paste on a substrate, and heating the applied conductive paste. The method is described below with reference to FIG. 1.

The conductive paste 10 is applied onto a substrate 11. There is no restriction on the substrate 11. The substrate 11 can be a polymer film, a glass substrate, a ceramic substrate or a semiconductor substrate in an embodiment. In another embodiment, the substrate 11 can be the polymer film or the semiconductor substrate that can be damaged by high temperature.

The conductive paste 10 can be applied on the substrate 11 by screen printing, inkjet printing, gravure printing, stencil printing, spin coating, blade coating or nozzle discharge in an embodiment. The screen printing can be taken in another embodiment because the screen printing can relatively easily form a desired pattern in a short time by using a screen mask.

The viscosity of the conductive paste is between 30 to 500 Pa measured by Brookfield HBT with a spindle #14 at 10 rpm in an embodiment. In the event of screen printing, the viscosity of the conductive paste can be 60 to 200 Pa's.

The applied conductive paste 10 is heated at 100 to 300° C. thereby the conductive paste is cured to become an electrode. The heating temperature can be 120 to 250° C. in another embodiment, 150 to 220° C. in another embodiment. The heating time can be 10 to 90 minutes in an embodiment, 15 to 70 minutes in another embodiment, and 20 to 45 minutes in another embodiment. The heating temperature can be adjustable by combination with heating time such as low temperature for longer time or higher temperature for a shorter time.

The pattern of the formed electrode may contain a line pattern having width of 1 μm to 10 mm and thickness of 1 to 100 μm in an embodiment, width of 30 μm to 6 mm and thickness of 3 to 70 μm in another embodiment, width of 100 μm to 3 mm and thickness of 8 to 30 μm in another embodiment. Such a line pattern can sometimes be required in electrical devices.

The non-fired electrode formed by the present invention exhibits long time heat resistance. The long time heat resistance can be represented by the resistivity ratio calculated as [Resistivity after aging/Initial Resistivity]. The resistivity ratio is preferably 2.0 or lower when the aging condition was 150° C. for 300 hours. The resistivity ratio is 1.5 or lower in another embodiment, 1.3 or lower in still another embodiment. The non-fired electrode with such low resistivity ratio can be used as a stable component in an electrical device for a long time.

The electrical resistivity of the electrode after the aging can be 1.5 mΩ·cm or lower in an embodiment, 1.0 mΩ·cm or lower in another embodiment.

The electrode manufactured by the method can be used in any electrical devices. Examples of the electrical devices are a solar cell, a touch-panel, a plasma display panel (PDP) and a light-emitting diode (LED) module.

### Conductive Paste

The conductive paste comprises at least (i) a conductive powder, (ii) an inorganic boron compound, (iii) an alcohol and (iv) an organic vehicle.

### Conductive Powder

The conductive powder is any powder having electrical conductivity.

The conductive powder can comprise a metal having conductivity of at least 1.00×10⁻¹ S·m⁻¹ at 293 Kelvin in an embodiment. The conductive powder comprises a metal selected from the group consisting of aluminum (Al), nickel (Ni), copper (Cu), silver (Ag), gold (Au), platinum (Pt), palladium (Pd), molybdenum (Mo), tungsten (W), zinc (Zn), an alloy thereof and a mixture thereof in another embodiment.

In another embodiment, the conductive powder can comprise a metal selected from the group consisting of Al, Ni, Zn, Cu, an alloy thereof and a mixture thereof. The conductive powder comprises Cu or Cu alloy in another embodiment. Such metals are relatively easily oxidized at high temperature but they can be used in the non-fired type electrode.

The conductive powder can comprise the alloy comprising a base metal such as Cu, Al, and Ni in another embodiment. Examples of the alloy are an alloy of aluminum and silicon (Al—Si), aluminum and copper (Al—Cu), aluminum and zinc (Al—Zn), aluminum and boron (Al—B), nickel and Niobium (Ni—Nb), nickel and boron (Ni—B), copper and nickel (Cu—Ni), copper and zing (Cu—Zn), copper and boron (Cu—B) and copper and tin (Cu—Sn).

The conductive powder comprising the base metal of Cu, Al, or Ni can be coated with a noble metal. The noble metal can be Ag, Au, Pt or alloy thereof. The noble metal to coat the base metal is Ag which is relatively inexpensive in another embodiment. The noble metal which has relatively low-level oxidation by being heated can reduce the base metal oxidation.

There is no limitation on shape of the conductive powder. However, a flaky conductive powder, spherical conductive powder or a mixture thereof are often used.

The particle diameter (D50) of the conductive powder can be 0.5 to 10 μm in an embodiment, 1 to 8 μm in another embodiment, 1.5 to 4 μm in another embodiment. The particle diameter within the range can be dispersed well in the paste. The conductive powder with such particle size can disperse well in the organic vehicle. The average diameter (D50) is obtained by measuring the distribution of the powder diameters by using a laser diffraction scattering method with Microtrac model X-100.

The conductive powder can be 40 to 90 weight percent (wt %) in an embodiment, 52 to 85 wt % in another embodiment, 65 to 80 wt % in another embodiment, based on the weight of the conductive paste. Within the range of conductive powder content, conductivity of the electrode can be sufficient.

### (ii) Inorganic Boron Compound

The inorganic boron compound is selected from the group consisting of boron oxide, boric acid, ammonium borate hydrate, borax, potassium tetraborate tetrahydrate and a mixture thereof. These types of inorganic boron compounds can keep the electrical resistivity low as shown in the Examples in Table 1 below.

The boron oxide is the oxide of boron. The boron oxide can be boron trioxide (B₂O₃) in an embodiment.

The boric acid can be selected from the group consisting of orthoboric acid (B(OH)₃, CAS No. 10043-35-3), metaboric acid (BHO₂, CAS No. 13460-50-9), tetrahydroxydiboron (B₂(OH)₄, CAS No. 13675-18-8) and a mixture thereof in an embodiment. The boric acid can be orthoboric acid in view of availability in the market in another embodiment.

The ammonium borate hydrate is ammonium pentaborate octahydrate, ammonium tetraborate tetrahydrate or a mixture thereof in an embodiment. Ammonium pentaborate octahydrate (CAS No. 12046-03-6) is formulated as (NH₄)₂B₁₀O₁₆.8H₂O and ammonium tetraborate tetrahydrate (CAS No. 12228-87-4) is formulated as (NH₄)₇B₄O₇.4H₂O. The ammonium borate hydrate is ammonium pentaborate octahydrate in another embodiment.

Borax (CAS No. 1303-96-4) is also called sodium borate decahydrate and formulated as Na₂B₄O₇.10H₂O.

Potassium tetraborate tetrahydrate (CAS No. 12045-78-2) is formulated as K₂B₄O₇.4H₂O.

In another embodiment, the inorganic boron compound is selected from the group consisting of boron oxide, boric acid, borax and a mixture thereof.

In another embodiment, the inorganic boron compound is selected from the group consisting of boron oxide, boric acid and a mixture thereof.

In another embodiment, the inorganic boron compound is selected from the group consisting of boron oxide, orthoboric acid and a mixture thereof.

The boron component in the inorganic boron compound is 0.05 to 0.6 parts by weight over 100 parts by weight of the conductive powder. The boron component in the inorganic boron compound is 0.08 to 0.5 parts by weight in another embodiment, 0.1 to 0.45 parts by weight in another embodiment, 0.2 to 0.4 parts by weight in still another embodiment, over 100 parts by weight of the conductive powder. With such an amount of boron component, the electrode can keep the electrical resistivity low through a high temperature aging as shown in the Examples below.

The amount of the boron component can be calculated from the amount of the inorganic boron compound by the following calculating formula.

Boron component (parts by weight)=Amount of inorganic boron compound (parts by weight)×(Atomic weight of boron: 10.81)×(Number of boron atom)/(Molecular weight of the inorganic boron compound)

For example, boron component of 5 parts by weight of B(OH)₃ (molecular weight: 61.83) is about 0.87 as a result of calculation of (5 parts by weight)×10.81×1/61.83. Boron component of 5 parts by weight of (NH₄)₂B₁₀O₁₆.8H₂O (molecular weight: 344.21) is about 1.57 as a result of calculation of (5 parts by weight)×10.81×10/344.21.

The inorganic boron compound is 0.1 to 8 parts by weight over 100 parts by weight of the conductive powder. The inorganic boron compound can be 0.2 to 5 parts by weight in another embodiment, 0.3 to 3 parts by weight in another embodiment, 0.5 to 1.5 parts by weight in another embodiment over 100 parts by weight of the conductive powder.

(iii) Alcohol

The alcohol is selected from the group consisting of glycerin, xylose and a mixture thereof. By adding such alcohol, the electrical resistivity of the non-fired type electrode can provide long-term heat resistance as shown in the Examples below.

Glycerin is an alcohol with three hydroxyl groups and the molecular weight of 92.09. Glycerin (CAS Number 56-81-5) can be expressed with the following chemical structure.

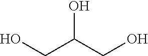

The xylose is a cyclic sugar alcohol with four hydroxyl groups and the molecular weight of 150.13. The molecular formula of the xylose is C₅H₁₀O₅.

The xylose can be selected from the group consisting of D-xylose, L-xylose, DL-xylose and a mixture thereof in an embodiment.

D-xylose (CAS Number 58-86-6) can be expressed with the following chemical structure.

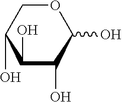

L-xylose (CAS Number 609-06-3) can be expressed with the following chemical structure.

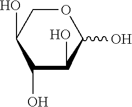

DL-xylose (CAS Number 25990-60-7) can be expressed with the following chemical structure.

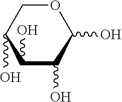

The xylose is D-xylose in another embodiment.

The alcohol is 0.1 to 8 parts by weight over 100 parts by weight of the conductive powder. The alcohol is 0.2 to 6 parts by weight in another embodiment, 0.3 to 4 parts by weight in another embodiment, 0.5 to 2 parts by weight in still another embodiment, over 100 parts by weight of the conductive powder. The conductive paste containing such amount of alcohol could form a non-fired type of electrode with a stable electrical resistivity as shown in Table 2 below in Example.

### (iv) Organic Vehicle

The conductive powder and the organic boron compound are dispersed into the organic vehicle to form a viscous composition called “paste”, having suitable viscosity for applying on a substrate with a desired pattern.

The organic vehicle is 20 to 150 parts by weight, 22 to 75 parts by weight in another embodiment, 25 to 50 parts by weight over 100 parts by weight of the conductive powder in another embodiment. The conductive paste containing such amount of the organic vehicle can form the electrode by the adequate applying method such as screen printing and inkjet printing as described above.

The organic vehicle can contain at least an organic polymer and optionally a solvent in an embodiment.

A wide variety of inert viscous materials can be used as the organic polymer, for example ethyl cellulose, ethylhydroxyethyl cellulose, wood rosin, epoxy resin, phenoxy resin, acrylic resin or a mixture thereof. The solvent such as texanol, terpineol or carbitol acetate can be used to adjust the viscosity of the conductive paste to be preferable for applying onto the substrate.

The organic vehicle can further comprise a photopolymerization initiator and a photopolymerizable compound when using a photolithographic method.

The photopolymerization initiator is thermally inactive at 185° C. or lower, but it generates free radicals when it is exposed to an actinic ray. A compound that has two intra-molecular rings in the conjugated carboxylic ring system can be used as the photopolymerization initiator, for example ethyl 4-dimethyl aminobenzoate (EDAB), diethylthioxanthone (DETX), and 2-methyl-1-[4-(methylthio)phenyl]-2-morpholinopropan-1-one. The photopolymerization initiator can be 2 to 9 wt % based on the weight of the organic vehicle in an embodiment.

The photopolymerization compound can comprise an organic monomer or an oligomer that includes ethylenic unsaturated compounds having at least one polymerizable ethylene group. Examples of the photopolymerization compound are ethocylated (6) trimethylolpropane triacrylate, and dipentaerythritol pentaacrylate.

The photopolymerization compound can be 20 to 45 wt % based on the weight of the organic vehicle in an embodiment.

For the organic vehicle to be used in photolithographic method, U.S. Pat. No. 5,143,819, U.S. Pat. No. 5,075,192, U.S. Pat. No. 5,032,490, U.S. Pat. No. 7,655,864 can be herein incorporated by reference.

### (iv) Additive

An organic additive such as a dispersing agent, a stabilizer and a plasticizer or an inorganic additive such as metal oxide powder can be added to the conductive paste based on a desired property of the formed electrode.

### EXAMPLES

The present invention is illustrated by, but is not limited to, the following Examples.

### Paste Preparation

Carbitol acetate as a solvent and phenoxy resin as an organic polymer were mixed together at 100° C. until all of phenoxy resin had dissolved to form the organic vehicle. The organic vehicle was filtered through a 20 micron mesh. Carbitol acetate was 75 wt, % and phenoxy resin was 25 wt. % based on the weight of the organic vehicle.

The conductive powder and the organic boron compound were added to the organic vehicle to mix well by a mixer followed by a three-roll mill, thereby the conductive paste was made.

The conductive paste composition is shown in Table 1 with component amounts as “parts by weight”.

The conductive powder was a spherical Cu—Zn alloy powder coated with Ag where Ag was 20 wt % based on the weight of the conductive powder. The particle diameter (D50) was 2.0 μm.

The inorganic boron compound was a powder of boron oxide (B₂O₃, CAS No. 1303-86-2), ammonium pentaborate octahydrate (APB, (NH₄)₂B₁₀O₁₆.8H₂O, CAS No. 12046-03-6) as the ammonium borate hydrate, borax (Na₂B₄O₅(OH)₄.8H₂O, CAS No. 71377-02-1), potassium tetraborate tetrahydrate (PTB, K₂B₄O₇.4H₂O. CAS No. 12045-78-2), sodium metaborate tetrahydrate (SMT, NaBO₂.4H₂O, CAS No. 98536-58-4), or orthoboric acid (B(OH)₃, CAS No. 10043-35-3) as the boric acid respectively.

The alcohol was glycerin (HOCH₂CH(OH)CH₂OH, GAS No. 56-81-5), ethanol (CH₃CH₂OH, CAS No, 64-17-5), myristyl alcohol (CH₃(CH₂)₁₃OH, CAS No. 112-72-1), ethylene glycol (HOCH₂CH₂OH, CAS No. 107-21-1) or D-Xylose (C₅H₁₀O₅, CAS No, 58-86-6) respectively.

### Manufacturing an Electrode

The conductive paste was screen printed onto an alumina substrate. The screen mask had a line pattern of 1.0 mm wide and 200 mm long. The printed conductive paste on the alumina substrate was heated at 150° C. for 30 minutes in a constant temperature oven (DN-42, Yamato Scientific Co., Ltd.).

### Measurement of Specific Electrical Resistance

The resistivity (mΩ·cm) was obtained by calculating the following equation (1). The resistance (mΩ) was measured with a multimeter (34401A from Hewlett-Packard Company). The maximum value of the measurable resistivity was 1×10¹⁰ mΩ·cm. The width was 0.1 cm, the thickness was 20 μm, and the length was 20 cm in average according to the measurement by a microscope having the measurement system.

Resistivity (mΩ·cm)=Resistance (mΩ)×electrode width (cm)×electrode thickness (μm)/electrode length (cm) (1)

The resistance was measured twice, at first right after forming the electrode and the second time is after aging in which the electrode was kept at 150° C. for 300 hours in a constant-temperature oven. The resistivity ratio [Resistivity after aging/Initial Resistivity] was calculated to see the long-term heat resistance. The smaller resistivity ratio indicates that the electrode has a higher long-term heat resistance.

### Result

The resistivity ratio was smaller than 2.0 in Examples 1 to 5 where the inorganic boron compound was B₂O₃, APB, Borax, PTB and orthoboric acid in combination with glycerin or xylose respectively as shown in Table 1. The resistivity after aging was sufficiently lower than 1.5 mΩ·cm in these Examples.

The resistivity ratio was higher than 2.0 such that the resistivity increased up to more than double in Comparative Examples (Com. Ex.) 1, 3 and 6. The initial resistivity was too high over 1×10⁷ mΩ·cm the maximum measurable resistivity of the multimeter so that the resistivity after aging was not measured in Comparative Examples 2, 4 and 5.

TABLE 1

| | | Com. | Com. | | | | | Com. | Com. | Com. | Com. | |
|---|---|---|---|---|---|---|---|---|---|---|---|---|
| | | Ex. 1 | Ex. 2 | Ex. 1 | Ex. 2 | Ex. 3 | Ex. 4 | Ex. 3 | Ex. 4 | Ex. 5 | Ex. 6 | Ex. 5 |
| Paste | Conductive | 100 | 100 | 100 | 100 | 100 | 100 | 100 | 100 | 100 | 100 | 100 |
| composition | powder | | | | | | | | | | | |
| (parts by | Inorganic | None | B₂O₃ | B₂O₃ | APB¹⁾ | Borax | PTB²⁾ | SMT³⁾ | B(OH)₃ | B(OH)₃ | B(OH)₃ | B(OH)₃ |
| weight) | boron | | | | | | | | | | | |
| | compound | 0 | 0.7 | 0.7 | 1.0 | 1.8 | 1.5 | 2.6 | 1.2 | 1.2 | 1.2 | 1.2 |
| | (Boron- | (0) | (0.2) | (0.2) | (0.2) | (0.2) | (0.2) | (0.2) | (0.2) | (0.2) | (0.2) | (0.2) |
| | component) | | | | | | | | | | | |
| | Alcohol | Glyc- | None | Glyc- | Glyc- | Glyc- | Glyc- | Glyc- | Ethanol | Myristyl | Ethylene | Xylose |
| | | erin | | erin | erin | erin | erin | erin | | Alcohol | glycol | |
| | | 3.1 | 0 | 3.1 | 3.1 | 3.1 | 3.1 | 3.1 | 3.1 | 3.1 | 3.1 | 3.1 |
| | Organic | 32.3 | 32.3 | 32.3 | 32.3 | 32.3 | 32.3 | 32.3 | 32.3 | 32.3 | 32.3 | 32.3 |
| | vehicle | | | | | | | | | | | |

| | | | | | | | | | | | | |
|---|---|---|---|---|---|---|---|---|---|---|---|---|
| Resistivity | Initial | 0.102 | >1 × 10¹⁰ | 0.209 | 0.209 | 0.231 | 0.332 | 0.246 | >1 × 10¹⁰ | >1 × 10¹⁰ | 1.000 | 0.592 |
| (mΩ · cm) | After | 0.225 | —⁴⁾ | 0.288 | 0.396 | 0.366 | 0.547 | 0.504 | —⁴⁾ | —⁴⁾ | 2.300 | 1.172 |
| | aging | | | | | | | | | | | |

| | | | | | | | | | | | |
|---|---|---|---|---|---|---|---|---|---|---|---|
| Resistivity ratio | 2.22 | —⁴⁾ | 1.38 | 1.90 | 1.59 | 1.65 | 2.05 | —⁴⁾ | —⁴⁾ | 2.20 | 1.98 |
| (After aging/Initial) | | | | | | | | | | | |

¹⁾Ammonium pentaborate octahydrate ((NH₄)₂B10₂O₁₆•8H₂O)
²⁾Potassium tetraborate tetrahydrate (K₂B₄O₇•4H2O)
³⁾Sodium metaborate tetrahydrate (NaBO₂•4H₂O)
⁴⁾The resistivity after aging and the resistivity ratio was not measured because the initial resistivity was over the maximum value of the measurable resistivity of 1 × 10¹⁰ mΩ · cm.

The amount of alcohol was examined. An electrode was formed in the same manner as in Example 1 except for using a conductive paste composition as shown in Table 2. Glycerin as the alcohol was used with different amounts in each Example.

The resistivity ratio was smaller than 2.0 in Examples 8 to 10 where Glycerin was 1, 3 and 5 parts by weight respectively as shown in Table 2. The resistivity after aging was also sufficiently lower than 1.5 mΩ·cm in these examples.

TABLE 2

| | | Ex. 8 | Ex. 9 | Ex. 10 |
|---|---|---|---|---|
| Paste | Conductive powder | 100 | 100 | 100 |
| composition | Organic vehicle | 32.3 | 32.3 | 32.3 |
| (parts by | Orthoboric acid | 1.0 | 1.0 | 1.0 |
| weight) | (Boron component) | (0.18) | (0.18) | (0.18) |
| | Glycerin | 1 | 3 | 5 |
| Resistivity | Initial | 0.252 | 0.078 | 0.117 |
| (mΩ · cm) | After aging | 0.280 | 0.099 | 0.167 |

| | | | |
|---|---|---|---|
| Resistivity ratio | 1.11 | 1.27 | 1.42 |
| (After aging/Initial) | | | |

The amount of boron was examined. An electrode was formed in the same manner as in Example 9 except for changing the amount of orthoboric acid as shown in Table 3. The boron component was different among the examples.

The resistivity ratio was smaller than 2.0 in Examples 9 and 11 where boron component in the inorganic boron compound was 0.18 and 0.36 parts by weight respectively as shown in Table 2. The resistivity after aging was also sufficiently lower than 1.5 mΩ·cm in these examples. In Comparative Example 7 where the boron component was 0.71 parts by weight, the resistivity ratio was 14.38 and the resistivity after aging was 252.6 mΩ·cm,

TABLE 3

| | | Ex. 9 | Ex. 11 | Com. Ex. 7 |
|---|---|---|---|---|
| Paste | Conductive powder | 100 | 100 | 100 |
| composition | Organic vehicle | 32.3 | 32.3 | 32.3 |
| (parts by | Orthoboric acid | 1.0 | 2.0 | 4.0 |
| weight) | (Boron component) | (0.18) | (0.36) | (0.71) |
| | Glycerin | 3 | 3 | 3 |
| Resistivity | Initial | 0.078 | 0.115 | 17.56 |
| (mΩ · cm) | After aging | 0.099 | 0.131 | 252.60 |

| | | | |
|---|---|---|---|
| Resistivity ratio | 1.27 | 1.14 | 14.38 |
| (After aging/Initial) | | | |

What is claimed is:

1. A method of manufacturing a non-fired type electrode comprising the steps of:
(a) applying a conductive paste on a substrate, wherein the conductive paste comprises,
(i) 100 parts by weight of a conductive powder;
(ii) 0.1 to 8 parts by weight of an inorganic boron compound selected from the group consisting of boron oxide, boric acid, ammonium borate hydrate, borax, potassium tetraborate tetrahydrate and a mixture thereof, wherein the boron component in the inorganic boron compound is 0.05 to 0.6 parts by weight;
(iii) 0.1 to 8 parts by weight of an alcohol selected from the group consisting of glycerin, xylose and a mixture thereof; and
(iv) an organic vehicle; and
(b) heating the applied conductive paste at 100 to 300° C.

2. The method of claim 1, wherein the conductive powder comprises a metal selected from the group consisting of aluminum (Al), nickel (Ni), copper (Cu), silver (Ag), gold (Au), platinum (Pt), palladium (Pd), molybdenum (Mo), tungsten (W), zinc (Zn), an alloy thereof and a mixture thereof.

3. The method of claim 2, wherein the conductive powder comprises a metal selected from the group consisting of Al, Ni, Zn, Cu, an alloy thereof and a mixture thereof.

4. A non-fired type conductive paste comprising;
(i) 100 parts by weight of a conductive powder;
(ii) 0.1 to 8 parts by weight of an inorganic boron compound selected from the group consisting of boron oxide, boric acid, ammonium borate hydrate, borax, potassium tetraborate tetrahydrate and a mixture thereof, wherein the boron component in the inorganic boron compound is 0.05 to 0.6 parts by weight;
(iii) 0.1 to 8 parts by weight of a alcohol selected from the group consisting of glycerin, xylose and a mixture thereof; and
(iv) an organic vehicle.

5. The non-fired type conductive paste of claim 4, wherein the conductive powder comprises a metal selected from the group consisting of aluminum (Al), nickel (Ni), copper (Cu), silver (Ag), gold (Au), platinum (Pt), palladium (Pd), molybdenum (Mo), tungsten (W), zinc (Zn), an ahoy thereof and a mixture thereof.

6. The non-fired type conductive paste of claim 4, wherein the conductive powder comprises a metal selected from the group consisting of Al, Ni, Zn, Cu, an alloy thereof and a mixture thereof.

7. An electrical device comprising the non-fired type electrode manufactured by the method of claim 1.
